(19) United States
(12) Patent Application Publication
(10) Pub. No.: US 2021/0227846 A1
(43) Pub. Date: Jul. 29, 2021

(54) COLD PRESSED OLIVE OIL HAVING FREE FATTY ACID CONTENT OF LESS THAN 0.1%

(71) Applicant: Pinhas Or, Kibbutz Yifat (IL)

(72) Inventor: Pinhas Or, Kibbutz Yifat (IL)

(21) Appl. No.: 16/775,331

(22) Filed: Jan. 29, 2020

(51) Int. Cl. A23D 9/02; A23D 9/013; C11B 1/06; C11B 3/10; C11B 3/00

(52) U.S. Cl. CPC A23D 9/02; A23D 9/013; C11B 3/001; C11B 3/10; C11B 1/06

(57) ABSTRACT

The present invention provides cold pressed olive oil having free fatty acid (FFA) content of less than 0.1% wt and processes for its preparation.

### BACKGROUND OF THE INVENTION

Olive oil is composed mainly of triacylglycerols (triglycerides or fats) and contains small quantities of free fatty acids (FFA), glycerol, phosphatides, pigments, flavor compounds, sterols, and microscopic bits of olive. Triacylglycerols are molecules derived from the natural esterification of three fatty acid molecules with a glycerol molecule. All other vegetable oils that have been tested (Canola, sesame, corn, rapeseed, grape seeds) are also triacylglycerols with similar general structure. The differences are in the internal structure composition of the fatty acids and the fatty acids type and their content (fatty acids profile). All the oils once obtained by cold press or are crude contain variety of impurities and mainly free fatty acids that are removed commercially by refining and deodorization of the oils (high temperature treatment). This report discuses explicitly two major oils—virgin and Lampante) but the conclusions are similar for all the other oils that have been tested.

A fatty acid has the general formula: CH₃(CH₂)ₙCOOH where n is typically an even number between 12 and 22. If no double bonds are present the molecule the fatty acid will be called a saturated fatty acid. If a chain contains double bonds, it is called an unsaturated fatty acid. A single double bond makes a monounsaturated fatty acid. More than one double bond makes a polyunsaturated fatty acid.

The major fatty acids in olive oil triacylglycerols are: Oleic Acid (C18:1), a monounsaturated omega-9 fatty acid. It makes 55 to 83% of olive oil; Linoleic Acid (C18:2), a polyunsaturated omega-6 fatty acid that makes up about 3.5 to 21% of olive oil; Palmitic Acid (C16:0), a saturated fatty acid that makes up 7.5 to 20% of olive oil; Stearic Acid (C18:0), a saturated fatty acid that makes up 0.5 to 5% of olive oil; Linolenic Acid (C18:3) (specifically alpha-Linolenic Acid), a polyunsaturated omega-3 fatty acid that makes up 0 to 1.5% of olive oil.

The composition of the fatty acids in olive oil is very unique since it is very rich in oleic acid (>60%), poor in saturated fatty acids (palmitic and steraric <15 wt) and poor in polyunsaturated fatty acids).

Olive oil contains more oleic acid and less linoleic and linolenic acids than other vegetable oils, that is, more monounsaturated than polyunsaturated fatty acids. This renders olive oil more resistant to oxidation because generally, the greater the number of double bonds in the fatty acid, the more unstable and easily broken down by heat, light, and other factors the oil is. It is generally accepted that cooler regions will yield oil with higher oleic acid than warmer climates.

Triacylglycerols are normally composed of a mixture of three fatty acids. Most prevalent in olive oil is the oleic-oleic-oleic (OOO) triacylglycerol, followed, in order of incidence, by palmitic-oleic-oleic (POO), then oleic-oleic-linoleic (OOL), then palmitic-oleic-linoleic (POL), then stearic-oleic-oleic (SOO), and so on.

There are several properties of the olive oil which are typical and serve as a fingerprint of the oil. Those properties are quite general and include the fatty acid profile and the internal fatty acid composition (positions of the fatty acids on the glycerol backbone)

Some properties and most the physical characteristics are general and specific to all the olive oils. Those are summarized below:

| | |
|---|---|
| Density or Specific Gravity | 0.9150-0.9180 @ 15.5° C. |
| Viscosity | 84 mPa · s (84 cP) at 20° C. |
| Specific Heat | 2.0 J/(g.)( ° C.) or .47 Btu/(1b.)(° F.) |
| Thermal Conductivity | 0.17 @ 20° C. |
| Dielectric Constant, e | 3.1 @ 20° C. |
| Density | 920 kg/m3 @ 20° C. or 7.8 lbs/U.S. Gallon |
| Volumetric Heat Capacity | 1.650 106 J/m3 @ 20° C. |
| Thermal Diffusivity | 10 × 10-8 m2/s @ 20° C. |
| Boiling Point | 570 degrees Fahrenheit |
| Calories per Tablespoon | About 120 calories |

In general, the uniqueness and benefits of olive oil are predominantly attributed to the oleic acid—a mono-unsaturated fatty acid of the cis configurationally isomer. The cis monounsaturated is very slow to oxidiize and along with the very significant antioxidants that are present in the cold press olive oil it is considered as oil resistant to oxidation.

The “acidity” in olive oil is the result of the degree of breakdown of the triacylglycerols, due to a chemical reaction called hydrolysis or lipolysis, in which free fatty acids are formed. Hydrolysis can occur chemically or enzymatically in the olives during their growth and it depends on variety of growth conditions. Hydrolysis can also occur during the harvesting, transport and storage or during the cold or hot-pressing stages.

Hydrolysis requires water and therefore, at any stage in which water is involved, hydrolysis can take place. Both acidic and alkaline conditions (acidic or alkaline pH) speed up and enhance the hydrolysis. The results of such hydrolysis free glycerol and free fatty acids (FFA) that are responsible for the acid value of acidity. In some cases, as a result of partial hydrolysis mono and diglycerides are formed along with free fatty acids. The free fatty acid (percentage) are also known as acidity of the oil and are expressed as quantity of titrated free fatty acids (expressed as oleic acid) in a given oil.

Factors which lead to a high free fatty acidity in an oil include fruit fly infestation, delays between harvesting and extraction (especially if the fruit has been bruised or damaged during harvesting), fungal diseases in the fruit (gloesporium, Macrophoma, etc.), prolonged contact between oil and vegetation water (after extraction), and careless extraction methods. Storing olives in heaps or silos to encourage enzymatic breakdown of cell structure, and thus facilitate oil release (as is the tradition in Portugal and other countries) is certainly not conducive to producing a high quality, low acidity oil.

Even oils made from fresh, healthy olives can have significant amounts of acidity, caused by anomalies during the actual biosynthesis of the oil in the olive fruit.

Oil extracted carelessly and/or from poor quality fruit suffers from a very significant breakdown of the triacylglycerides into fatty acids.

The free fatty acidity is a direct measure of the quality of the oil, and reflects the care taken right from blossoming and fruit set to the eventual sale and consumption of the oil.

Fatty acids are oxidation is not one single reaction, but a complex series of reactions. When oil oxidizes it produces a series of breakdown products in stages, starting with primary oxidation products (peroxides, dienes, free fatty acids), then secondary products (carbonyls, aldehydes, trienes) and finally tertiary products. Oxidation progresses at different rates depending on factors such as temperature, light, availability of oxygen, and the presence of moisture and metals (such as iron). The type of oil influences the rate of oxidation. The olive oil which is poor in polyunsatutrted fatty acids and rich in antioxidants is very resistant to oxidation and formation of peroxides or fragmented fractions (aldehydes and ketons). Other oils rich in poly unsaturated fatty acids have reactive double bonds between their carbon atoms, whereas are much more sensitive to oxidation.

Two major oxidation process are common in vegetable and fruit oils: Auto-oxidation occurs by reactive oxygen species or “free radicals”. It is temporarily prevented by the natural antioxidants in the oil that absorb these free radicals. When the antioxidants are used, the oil ages quickly. Photo-oxidation occurs when the oil is exposed to natural and/or artificial light sources (including halogen lights and store lights). It causes serious deterioration of olive oil, as it can occur up to 30,000 times faster than auto-oxidation.

The more rancid or oxidized the oil, the more peroxides are present. Measurement of the peroxides in olive oil is a very simple procedure which can be done at a certified analytical lab.

Olive Oil Grades—Standards

The International Olive Committee's (IOC) olive oil standards specify the precise measurement thresholds to be met for oils to be graded as extra virgin, virgin, and so on. Whenever analytical parameters (FFA, PV, and UV) exceed a given threshold, the oil is classified as the next lower quality grade. There are several categories of olive oils and each is defined by its own appearance, specification and performance properties.

Categorization of Olive Oil is Based on the IOOC Standards:
Extra Virgin Olive Oil—The highest quality of olive oil. Virgin olive oil which has a free acidity, expressed as oleic acid, of no more than 0.8 grams per 100 grams (0.8%), and whose other characteristics correspond to those fixed for this category in the IOOC standards.
Extra virgin olive oil accounts for less than 10% of oil in many producing countries. Note that extra virgin olive oils vary widely in taste, color, and appearance. Their taste and aroma should reflect the fact that they were made from olives and have some positive attributes (that is, they cannot be totally tasteless). They are supposed to have no after taste defects.
Virgin Olive Oil—Virgin olive oil which has a free acidity, expressed as oleic acid, of not more than 2 grams per 100 grams (2.0%), and whose other characteristics correspond to those fixed for this category in the IOOC standards.
Ordinary Virgin Olive—Virgin olive oil which has a free acidity, expressed as oleic acid, of not more than 3.3 grams per 100 grams (3.3%), and whose other characteristics correspond to those fixed for this category in the IOOC standards. This is an inferior oil with notable defects. Although this olive oil is under the edible category, in most countries it is intended for refining or for technical use
Lampante Virgin Olive Oil which has a free acidity, expressed as oleic acid, of more than 3.3 grams per 100 grams (3.3%) and/or organoleptic and other characteristics corresponding to those fixed for this category in the IOOC standards. It is intended for refining or for technical use. Lampante virgin olive oil comes from bad fruit or careless processing. It is not fit for human consumption as it is.
Refined Olive Oil—Refined olive oil is the olive oil obtained from virgin olive oils by refining methods that do not lead to alterations in the initial glyceridic structure. It has a free acidity, expressed as oleic acid, of no more than 0.3 grams per 100 grams (0.3%) and its other characteristics correspond to those fixed for this category in the IOOC standards. This oil is obtained by refining virgin olive oils (not olive-pomace oils) that have a high acidity level and/or organoleptic defects which are eliminated after refining. Over 50% of the oil produced in the Mediterranean area is of such poor quality that it must be refined to produce an edible product. Note that no solvents have been used to extract the oil, but it has been refined with the use of other chemical and physical filters. An obsolete equivalent is “pure olive oil”. Refined oil is generally tasteless, odorless, and colorless. Many countries deem it unfit for human consumption due to poor flavor, not due to safety concerns. It is not officially described as “not fit for human consumption as it is” in the IOOC definitions, however.
Olive Oil—Olive oil is the oil consisting of a blend of refined olive oil and virgin olive oil fit for consumption as they are. It has a free acidity, expressed as oleic acid, of not more than 1 gram per 100 grams (1.0%). The cheap refined oil is mixed with more flavorful virgin oil. Some countries require a more specific designation. Most of the olive oil sold in the world falls into this category. Different blends are made, with more or less virgin oil, to achieve different tastes at different prices. Oils described as “Light” or “Extra Light” in the United States fall in this category, and are most likely made with a large proportion of refined oil.
Olive-Pomace Oils—Pomace is the ground flesh and pits left after pressing. Olive-pomace oil is the oil obtained by treating olive pomace with solvents or other physical treatments, to the exclusion of oils obtained by re-esterification processes and of any mixture with oils of other kinds. It is considered an inferior grade and is used for soap making or industrial purposes.
Crude Olive-Pomace Oil—Crude olive-pomace oil is olive-pomace oil whose characteristics correspond to those fixed for this category in the IOOC standards. It is intended for refining for use for human consumption, or for technical use. It is not really fit for human consumption as it is.
Refined Olive-Pomace Oil—Refined olive-pomace oil is the oil obtained from crude olive-pomace oil by refining methods which do not lead to alterations in the initial glyceridic structure. It has a free acidity, expressed as oleic acid, of not more than 0.3 grams per 100 grams and its other characteristics correspond to those fixed for this category in the IOOC standards. It is generally refined by the same methods as Refined Olive Oil, except that the raw product is crude olive-pomace oil instead of low quality virgin oil. It is not considered fit for human consumption in many countries because of flavor considerations.

Olive-Pomace Oil—Olive pomace oil is the oil comprising the blend of refined olive-pomace oil and virgin olive oil fit for consumption as they are. It has a free acidity of no more than 1 gram per 100 grams (1%) and its other characteristics correspond to those fixed for this category in the IOOC standards. In no case shall this blend be called “olive oil”.

USA Specifications for Olive Oil—§ 52.1534 Grades of Olive Oil
“U.S. Extra Virgin Olive Oil” is virgin olive oil which has excellent flavor and odor (median of defects equal to zero and median of fruitiness greater than zero) and a free fatty acid content, expressed as oleic acid, of not more than 0.8 grams per 100 grams, and meets the additional requirements as outlined in § 52.1539, as appropriate.
“U.S. Virgin Olive Oil” is virgin olive oil which has reasonably good flavor and odor (median of defects between zero and 2.5 and median of fruitiness greater than zero) and a free fatty acid content, expressed as oleic acid, of not more than 2.0 grams per 100 grams, and meets the additional requirements as outlined in § 52.1539 as appropriate. Olive oil that falls into this classification shall not be graded above “U.S. Virgin Olive Oil” (this is a limiting rule).
“U.S. Virgin Olive Oil—Not Fit For Human Consumption Without Further Processing” sometimes designated as “U.S. Lampante Virgin Olive Oil,” is virgin olive oil which has poor flavor and odor (median of defects between 2.5 and 6.0 or when the median of defects is less than or equal to 2.5 and the median of fruit is zero), a free fatty acid content, expressed as oleic acid, of more than 2.0 grams per 100 grams, and meets the additional requirements as outlined § 52.1539 as appropriate. Olive oil that falls into this classification shall not be graded above “U.S. Virgin Olive Oil Not Fit for Human Consumption Without Further Processing” (this is a limiting rule). It is intended for refining or for purposes other than food use.
“U.S. Olive Oil”—is the oil consisting of a blend of refined olive oil and virgin olive oils fit for consumption without further processing. It has a free fatty acid content, expressed as oleic acid, of not more than 1.0 gram per 100 grams, has acceptable odor and flavor characteristic of “virgin olive oil,” and meets the additional requirements as outlined in § 52.1539 as appropriate. Olive oil that falls into this classification shall not be graded above “U.S. Olive Oil” (this is a limiting rule). The maximum level permitted of total alpha-tocopherol in the final product is 200 mg/kg.
“U.S. Refined Olive Oil” is the olive oil obtained from virgin olive oils by refining methods that do not lead to alterations in the initial glyceridic structure (basic glycerin-fatty acid structure). It has a free fatty acid content, expressed as oleic acid, of not more than 0.3 grams per 100 grams, is flavorless and odorless.
Olive oil that falls into this classification shall not be graded above “U.S. Refined Olive Oil” (this is a limiting rule). The addition of alpha-tocopherol is permitted to restore natural tocopherol lost in the refining process. The maximum level is 200 mg/kg of total alpha-tocopherol in the final product.
Olive-pomace Oils—are graded based on the minimum criteria outlined in Table I, as appropriate. The hierarchy for grades from highest to lowest is olive-pomace oil, refined olive-pomace oil, and crude olive-pomace oil.
Crude olive-pomace oil is the lowest level of quality among the olive pomace oils and must be refined before consumption.

It is important to understand that the need for standardizing the quality of olive oil for human consumption stems from the abundance of evidence showing that consuming vegetable oil having high content of free fatty acids is harmful to human health. Research has shown that high levels of free fatty acid (FFA) in the blood serum are associated with metabolic syndrome (MS), severe liver diseases (Gut, 1961, 2, 304), and insulin resistance (Lupus. 2013; 22(1): 26-33). These findings and others together with the growing consumption of vegetable oil represents a growing need for healthier cold pressed olive oil, capable of being produced in environmentally safe process.

### SUMMARY OF THE INVENTION

Typical vegetable oils are composed of glycerol molecules that are each attached to 3 fatty acids. When vegetable oil is subjected to distilled water and degrading enzymes free fatty acids (FFA) are released. The acidity level of the vegetable oil is measured by the content of FFA (in % wt) this measurement is a key parameter in determining the oils quality and price. High contents of FFA in vegetable oil make it less stable, prone to oxidation and to turning rancid and unhealthy for human consumption. Typically, FFA levels of cold pressed olive oil is above 1.5% wt and higher. There is a growing need to produce cold pressed olive oil that has low FFA content, having longer shelf life, that is healthier for human consumption

It is noted that in the content of the present invention the term “cold pressed olive oil” should be understood to encompass pure olive oil, that is not blended or mixed with any other vegetable oil, that is produced from the olive fruit in a cold press process (i.e. oil is obtained through pressing olive fruit with a steel press. Although pressing produces heat through friction, the fruit is not precooked and consequently the oil is considered cold pressed—in contrast to large scale solvent extraction and refining operations which strip the oil of natural antioxidants, vitamins and flavor).

Until this date, there is no olive oil produced in a cold press process having FFA levels of below 0.1%. The process in the present invention enable the production of new and healthies vegetable oil. Thus, the present invention provides cold pressed olive oil having free fatty acid (FFA) content of less than 0.1% wt.

The invention further provides a process for producing cold pressed olive oil having FFA content of less than 0.1%; said process comprising the steps of: (a) crashing the olive fruit to form a paste of olive oil, distilled water and none dissolvable solids; (b) malaxing the paste; (c) separating/decanting the olive oil from the none dissolvable solids (filtering said none dissolved solids); (d) centrifuging the olive oil to remove distilled water; wherein at least one solid particulate adsorbent of FFA is added at least once before, during or after any step; thereby producing cold pressed olive oil having FFA content of less than 0.1%.

It is noted that in the content of the invention, the term “at least one solid particulate adsorbent of FFA” refers to any compound or combination of compounds that are in the solid particulate form, being immiscible in vegetable oil, capable of being substantially separated from vegetable oil by typical separation/decanting processes having specific weight/density higher than said vegetable oil. However, upon mixing of said adsorbent with vegetable oil said compound or combination of compounds is capable of adsorbing on its surface free fatty acids contained in said vegetable oil or pressed paste of said vegetable.

Furthermore, said at least one solid particulate adsorbent of FFA is defined as a food grade compound or combination of compounds that are typically allowed for use in the food industry. It is further noted that said at least one solid particulate FFA adsorbent allows for the production of vegetable oil that is defined as cold pressed and not refined. The production process as disclosed in the present invention does not require the use of elevated temperature. The use of said at least one solid particulate FFA adsorbent allows for the production of vegetable oil without altering any of the vegetable oil parameters and characteristics (such as taste, color, boiling temperature, contents other than FFA, oxidation levels, and so forth).

The invention further provides a process for the adsorbing and filtering of free fatty acids in cold pressed olive oil. The invention further provides a process for producing cold pressed olive oil having FFA content of less than 1%; said “Adsorption/Filtration FFA process” comprising the steps of: (a) providing cold pressed olive oil having FFA content of higher than 1% wt; (b) adding to said oil at least one solid particulate adsorbent of FFA and distilled water; (c) mixing said olive oil, distilled water and said at least one solid particulate adsorbent of FFA; (d) decanting/separating the olive oil and/filtering said at least one solid particulate adsorbent of FFA; (e) centrifuging the olive oil to remove distilled water; thereby producing cold pressed olive oil having FFA content of less than 1%.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A-1D is show a schematic cold press process of the invention for obtaining olive oil of the present invention.

FIG. 2 shows an embodiment of a process of the invention wherein FFA in cold pressed olive oil is adsorbed and then filtered.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The present invention provides olive oil having free fatty acid (FFA) content of less than 0.1% wt wherein said oil is cold pressed oil.

In some embodiments, said cold pressed olive oil has free fatty acid content is less than 0.1% wt. In other embodiments, said olive oil has FFA content of between about 0.1 to 0.05% wt. In further embodiments, said olive oil has FFA content of less than 0.05% wt. In other embodiments, said olive oil has FFA content of between about 0.05 to 0.01% wt. In yet other embodiments, said olive oil has FFA content of less than 0.01% wt.

The invention further provides a process for producing cold pressed olive oil having FFA content of less than 0.1%; said process comprising the steps of: (a) crashing the olive fruit to form a paste of olive oil, distilled water and none dissolvable solids; (b) malaxing the paste; (c) separating/decanting the olive oil from the none dissolvable solids (filtering said none dissolved solids); (d) centrifuging the olive oil to remove distilled water; wherein at least one solid particulate adsorbent of FFA is added at least once before, during or after any step; thereby producing cold pressed olive oil having FFA content of less than 0.1%.

The invention further provides a process for producing cold pressed olive oil having FFA content of less than 1%; said process comprising the steps of: (a) crashing the olive fruit to form a paste of olive oil, distilled water and none dissolvable solids; (b) malaxing the paste; (c) separating/decanting the olive oil from the none dissolvable solids; (d) centrifuging the olive oil to remove distilled water; wherein at least one solid particulate adsorbent of FFA is added at least once before, during or after any step; thereby producing cold pressed olive oil having FFA content of less than 1%.

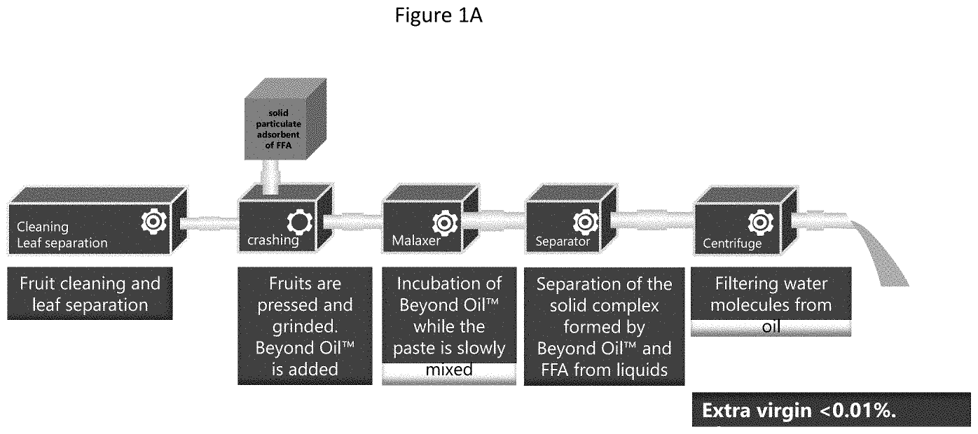

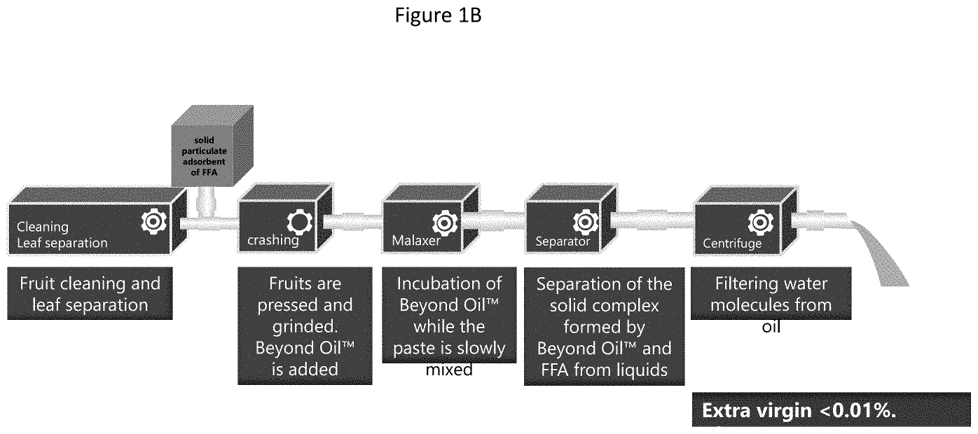

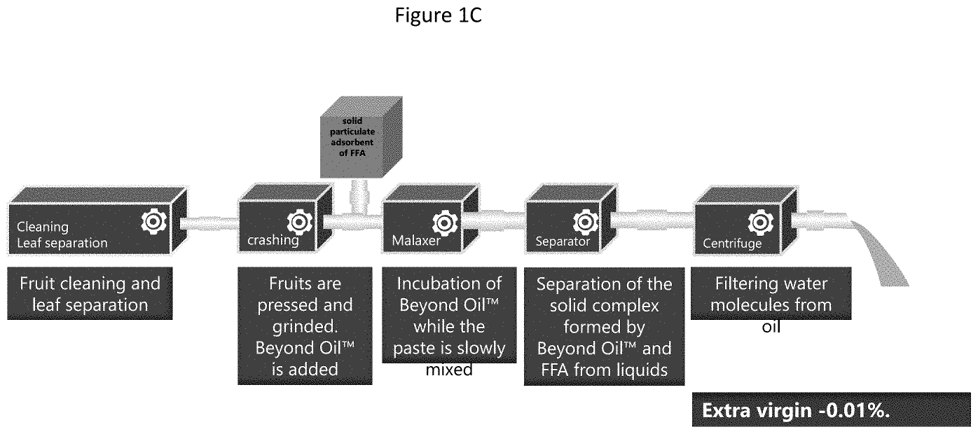

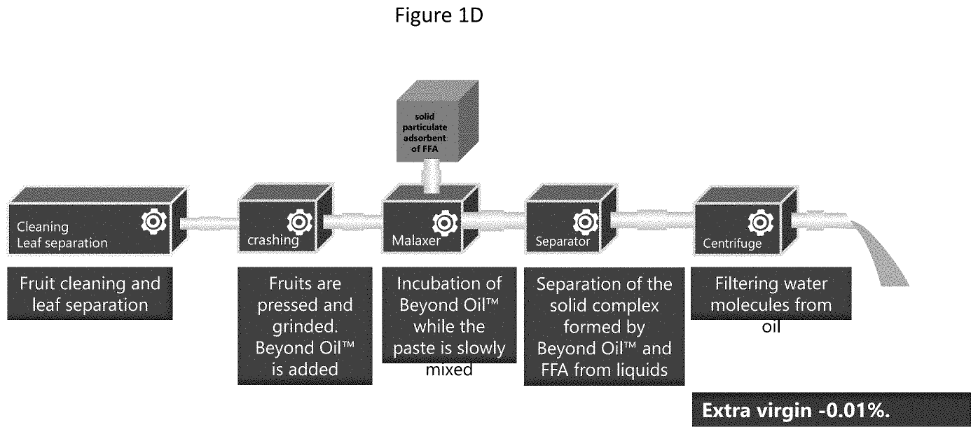

In some embodiments of a process of the invention said at least one solid particulate adsorbent is added at step (a). In other embodiments of the process of the invention, said at least one solid particulate adsorbent is added prior to step (a). In yet other embodiments of a process of the invention, said at least one solid particulate adsorbent is added is added at step (b). In some embodiments of a process of the invention said at least one solid particulate adsorbent is added prior to step (b). In some embodiments of a process of the invention said at least one solid particulate adsorbent is added at step (c). In some embodiments of a process of the invention said at least one solid particulate adsorbent is added prior to step (c). FIGS. 1A to 1D provide the different embodiments of a process of the invention.

In some embodiments of a process of the invention said at least one solid particulate adsorbent is selected from silicate, TALC, Ginger extract, Coconut water extract, Aloe Vera Extract and any combinations thereof.

The invention further provides a process for producing cold pressed olive oil having FFA content of less than 1%; said process comprising the steps of: (a) providing cold pressed olive oil having FFA content of higher than 1% wt; (b) adding to said oil at least one solid particulate adsorbent of FFA and distilled water; (c) mixing said olive oil, distilled water and said at least one solid particulate adsorbent of FFA; (d) decanting/separating the olive oil and filtering said at least one solid particulate adsorbent of FFA; (e) centrifuging the olive oil to remove distilled water; thereby producing cold pressed olive oil having FFA content of less than 1%.

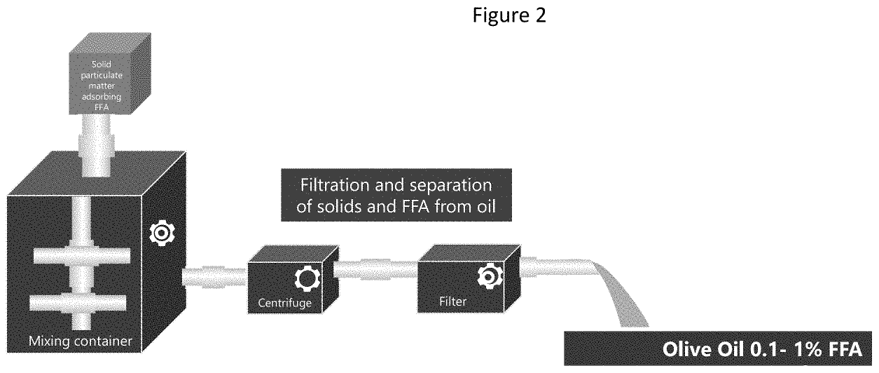

FIG. 2 provides a schematic representation of such a process. The cold pressed olive oil is added to the mixing container, and at least one solid particulate adsorbent of FFA and distilled water and while the oil, thereafter the solid none dissolved particulate matter adsorbing said FFA is filtered out of the oil.

In some embodiments of a process of the invention, the process produces olive oil having free fatty acid (FFA) content of less than 0.5% wt. In some embodiments of a process of the invention, the process produces olive oil having free fatty acid (FFA) content of less than 0.1% wt. In other embodiments, a process of the invention produces olive oil having free fatty acid content of between about 0.1 to 0.05% wt. In further embodiments, a process of the invention produces olive oil having free fatty acid content of less than 0.05% wt. In yet other embodiments, a process of the invention produces olive having free fatty acid content of between about 0.05 to 0.01% wt. In other embodiments, a process of the invention produces olive oil having free fatty acid content of less than 0.01% wt.

The invention provides olive oil having FFA content of less than 1%, being produced by a process of the present invention. In some embodiments, said olive oil has FFA content of less than 0.5% wt. In other embodiments, said olive oil has FFA content of between 1 to 0.5%. In some embodiments, said olive oil has FFA content of less than 0.1% wt. In other embodiments, said olive oil has FFA content of between 0.5 to 0.1%.wt.

Table 1 below shows the FFA levels achieved for samples of olive oil of the invention using a process of the present invention:

TABLE 1
Olive Oil of the Invention

| | | | Time | | | |
|---|---|---|---|---|---|---|
| EXP | | Olive | of | FFA | AVERAGE | |
| # | EXP Tile | (Kg) | mixing | results | (AVG) | STDEV |
| 1 A | Control | 50 | 1 hr | 2.5 | 2.5 | 0 |
| 1 B | Control | 50 | | 2.5 | | |
| 1 C | Control | 50 | | 2.5 | | |
| 1 D | Control | 50 | | 2.5 | | |
| 1 E | Control | 50 | | 2.5 | | |
| 2.1 A | Liquid 2.1 | 250 | 1 hr | 0.01 | 0.012 | 0.004 |
| 2.1 B | Liquid 2.1 | 250 | | 0.01 | | |
| 2.1 C | Liquid 2.1 | 250 | | 0.01 | | |
| 2.1 D | Liquid 2.1 | 250 | | 0.02 | | |
| 2.1 E | Liquid 2.1 | 250 | | 0.01 | | |
| 2.2 A | Liquid 2.2 | 312 | 1 hr | 0.03 | 0.016 | 0.009 |
| 2.2 B | Liquid 2.2 | 312 | | 0.01 | | |
| 2.2 C | Liquid 2.2 | 312 | | 0.01 | | |
| 2.2 D | Liquid 2.2 | 312 | | 0.01 | | |
| 2.2 E | Liquid 2.2 | 312 | | 0.02 | | |
| 3.1 A | Powder 3.1 | 250 | 1 hr | 0.02 | 0.022 | 0.008 |
| 3.1 B | Powder 3.1 | 250 | | 0.03 | | |
| 3.1 C | Powder 3.1 | 250 | | 0.03 | | |
| 3.1 D | Powder 3.1 | 250 | | 0.02 | | |
| 3.1 E | Powder 3.1 | 250 | | 0.01 | | |
| 3.2 A | Powder 3.2 | 250 | 1 hr | 0.01 | 0.012 | 0.004 |
| 3.2 B | Powder 3.2 | 250 | | 0.01 | | |
| 3.2 C | Powder 3.2 | 250 | | 0.02 | | |
| 3.2 D | Powder 3.2 | 250 | | 0.01 | | |
| 3.2 E | Powder 3.1 | 250 | | 0.01 | | |

Table 2 shows the FFA levels of olive oil samples before and after treatment of a process of the invention.

TABLE 2
FFA levels of olive oil before and after treatment

| Olive Oil | FFA % wt prior | FFA % wt post treatment |
|---|---|---|
| Sample # | to treatment | of the invention |
| 1 | 1.2 | 0.01 |
| 2 | 1.5 | 0.01 |
| 3 | 1.7 | 0.02 |
| 4 | 0.8 | 0.01 |
| 5 | 1.1 | 0.01 |
| 6 | 2.4 | 0.02 |
| 7 | 2 | 0.02 |
| 8 | 2.2 | 0.02 |
| 9 | 2.25 | 0.02 |
| 10 | 2.45 | 0.03 |
| 11 | 2.55 | 0.03 |
| 12 | 1.85 | 0.02 |
| 13 | 1.7 | 0.01 |
| 14 | 2.3 | 0.03 |
| 15 | 1.55 | 0.02 |
| 16 | 1.42 | 0.01 |
| 17 | 1.63 | 0.02 |
| 18 | 2.8 | 0.02 |
| 19 | 3.2 | 0.01 |
| 20 | 3.6 | 0.03 |
| 21 | 3.85 | 0.02 |
| 22 | 3.35 | 0.01 |
| 23 | 3.7 | 0.02 |
| 24 | 3.85 | 0.02 |
| 25 | 2.45 | 0.01 |
| 26 | 1.72 | 0.03 |
| 27 | 0.95 | 0.02 |
| 28 | 2.72 | 0.02 |
| 29 | 2.2 | 0.01 |
| 30 | 0.8 | 0.01 |
| 31 | 0.6 | 0.01 |
| 32 | 0.5 | 0.01 |
| 33 | 1.15 | 0.01 |
| 34 | 1.55 | 0.02 |
| 35 | 1.65 | 0.02 |
| 36 | 1.8 | 0.02 |
| 37 | 1.95 | 0.01 |
| 38 | 2 | 0.01 |
| 39 | 3.1 | 0.02 |
| AVR | 2.05 | 0.017 |
| STDEV | 0.9 | 0.007 |
| Range | 0.5-3.85 | 0.01-0.03 |

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. Olive oil having free fatty acid (FFA) content of less than 0.1% wt wherein said oil is cold pressed oil.

2. Olive oil of claim 1, having free fatty acid content of between about 0.1 to 0.05% wt.

3. Olive oil of claim 1, having free fatty acid content of less than 0.05% wt.

4. Olive oil of claim 1, having free fatty acid content of less than 0.01% wt.

5. A process for producing cold pressed olive oil having FFA content of less than 1%; said process comprising the steps of:
a. crashing the olive fruit to form a paste of olive oil, distilled water and none dissolvable solids;
b. malaxing the paste;
c. separating/decanting the olive oil from the none dissolvable solids;
d. centrifuging the olive oil to remove distilled water;
e. wherein at least one solid particulate adsorbent of FFA is added at least once before, during or after any step; thereby producing cold pressed olive oil having FFA content of less than 1%.

6. A process according to claim 5, wherein said at least one solid particulate adsorbent is added at or before step (a).

7. A process according to claim 5 wherein said at least one solid particulate adsorbent is added is added at or before step (b).

8. A process according to claim 5, wherein said at least one solid particulate adsorbent is added at or before step (c).

9. A process according to claim 5, wherein said at least one solid particulate adsorbent is selected from silicate, TALC, Ginger extract, Coconut water extract, Aloe Vera Extract and any combinations thereof.

10. A process for producing cold pressed olive oil having FFA content of less than 1%; said process comprising the steps of:
(a) providing cold pressed olive oil having FFA content of higher than 1% wt;
(b) adding to said oil at least one solid particulate adsorbent of FFA and distilled water;
(c) mixing said olive oil, distilled water and said at least one solid particulate adsorbent of FFA;
(d) decanting/separating the olive oil and filtering said at least one solid particulate adsorbent of FFA;
(e) centrifuging the olive oil to remove distilled water; thereby producing cold pressed olive oil having FFA content of less than 1%.
